(19) United States
(12) Patent Application Publication
(10) Pub. No.: US 2007/0248725 A1
(43) Pub. Date: Oct. 25, 2007

(54) Method of processing foods and apparatus therefor

(76) Inventors: Tsung-li Li, Taichung (TW); Tsung-hwa Li, Taichung (TW); Jeng-yan Li, Taichung (TW); Guan-shing Li, Taichung (TW)

Correspondence Address: SAM CHEN, 7F-1, 293, ROOSEVELT ROAD, SEC 3, TAIPEI, omitted

(21) Appl. No.: 11/736,588

(22) Filed: Apr. 18, 2007

(30) Foreign Application Priority Data
Apr. 21, 2006 (TW) 095114191

(51) Int. Cl. A23L 2/00

(52) U.S. Cl. 426/330.5; 426/443

(57) ABSTRACT

Method of processing foods and drying apparatus therefor are disclosed. The method includes cutting vegetables, fruits, fish, or meats into pieces; squeezing the pieces for juice; drying the juice in a closed space having a humidity of about zero maintained at a temperature of about 18° C. to about 28° C. until the juice either has a water percentage of about 20% to about 25% or has a sugar percentage of about 60 degrees for forming a paste; mixing the paste with malt; feeding the mixture into the space for drying until the mixture has a water percentage of about 12% to about 15% and grinding same into coarse powder; further drying the coarse powder until the coarse powder has a water percentage less than about 9%, and grinding same into fine powder. The apparatus includes a dehumidifier including a condenser coil and fins having a density increased upward.

### BACKGROUND OF THE INVENTION

1. Field of Invention

The present invention relates to food processing and more particularly to a method of processing foods (e.g., vegetables, fruits, fish, or meats) into powder, capsules or small pieces and a drying apparatus therefor with improved characteristics including nutrients being preserved.

2. Related Art

Food processing techniques are well known. For example, dehydration is often employed as means for conserving foods. However, nutrients are susceptible to being lost in the conventional food processing apparatuses. Thus, the need for improvement still exists.

### SUMMARY OF THE INVENTION

It is therefore an object of the present invention to provide a method of processing foods including vegetables, fruits, fish, and meats into powder, capsules or small pieces and a drying apparatus therefor for preserving nutrients.

The above and other objects, features and advantages of the present invention will become apparent from the following detailed description taken with the accompanying drawings.

### BRIEF DESCRIPTION OF THE DRAWINGS

FIG. 1 is a flowchart depicting a process for processing vegetables or fruits into fine powder, capsules or small pieces according to a first preferred embodiment of the invention;

FIG. 2 is a flowchart depicting a process for processing fish or meats into fine powder, capsules or small pieces according to a second preferred embodiment of the invention;

FIG. 3 is a flowchart depicting a process for processing vegetables or fruits of highly adhesive substance into fine powder, capsules or small pieces according to a third preferred embodiment of the invention;

FIG. 4 is a flowchart depicting a process for processing vegetables or fruits of highly adhesive substance into very fine powder, capsules or small pieces according to a fourth preferred embodiment of the invention;

FIG. 5 is a flowchart depicting a process for processing vegetables or fruits into very fine powder, capsules or small pieces according to a fifth preferred embodiment of the invention; and

FIG. 6 is a perspective view schematically showing a drying apparatus for food processing according to the invention.

### DETAILED DESCRIPTION OF THE INVENTION

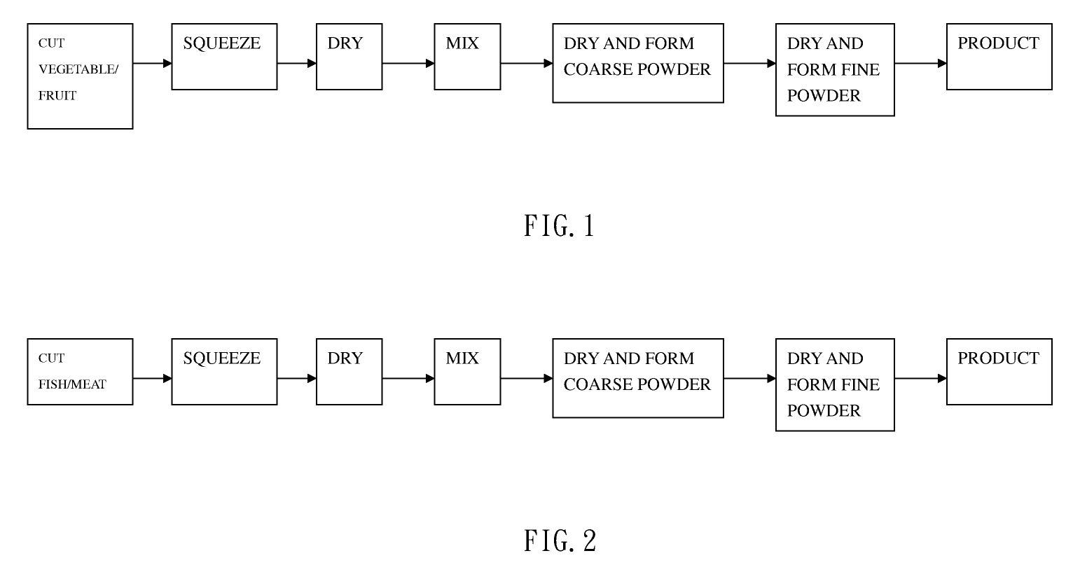

Referring to FIG. 1, it is a flowchart depicting a process for processing vegetables or fruits into fine powder, capsules or small pieces according to a first preferred embodiment of the invention. The process comprises cutting vegetables or fruits into small pieces; squeezing the pieces for juice; drying the juice in a closed space of very low humidity maintained at a temperature of about 18° C. to about 28° C. until the juice either has a water percentage of about 20% to about 25% or has a sugar percentage of about 60 degrees for forming a paste; mixing the paste with a predetermined amount of malt; feeding the mixture into the closed space of very low humidity maintained at a temperature of about 18° C. to about 28° C. for drying until the mixture has a water percentage of about 12% to about 15% and grinding same into coarse powder; further drying the coarse powder until the coarse powder has a water percentage less than about 9% and grinding same into fine powder; and packing the fine powder as bags or cans or forming same as capsules or small pieces.

Referring to FIG. 2, it is a flowchart depicting a process for processing fish or meats into fine powder, capsules or small pieces according to a second preferred embodiment of the invention. The process comprises cutting fish or meats into small pieces; squeezing the pieces for juice; drying the juice in a closed space of very low humidity maintained at a temperature of about 18° C. to about 28° C. until the juice either has a water percentage of about 20% to about 25% or has a sugar percentage of about 60 degrees for forming a paste; mixing the paste with a predetermined amount of malt; feeding the mixture into the closed space of very low humidity maintained at a temperature of about 18° C. to about 28° C. for drying until the mixture has a water percentage of about 12% to about 15% and grinding same into coarse powder; further drying the coarse powder until the coarse powder has a water percentage less than about 9% and grinding same into fine powder; and packing the fine powder as bags or cans or forming same as capsules or small pieces.

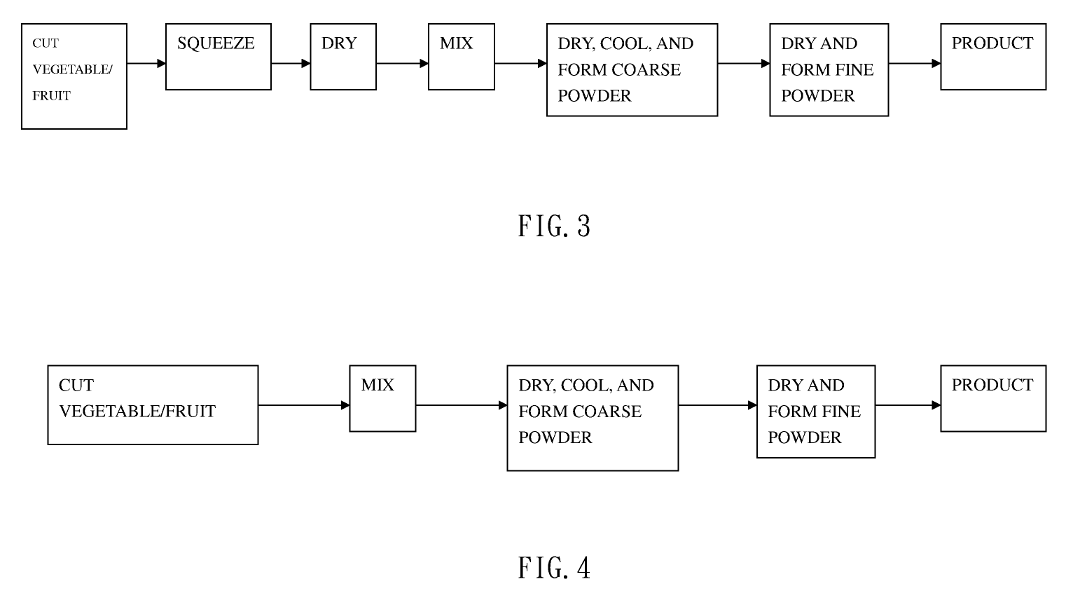

Referring to FIG. 3, it is a flowchart depicting a process for processing vegetables of highly adhesive substance (e.g., onions) or fruits of highly adhesive substance into fine powder, capsules or small pieces according to a third preferred embodiment of the invention. The process comprises cutting vegetables or fruits into small pieces; squeezing the pieces for juice; drying the juice in a closed space of very low humidity maintained at a temperature of about 18° C. to about 28° C. until the juice either has a water percentage of about 20% to about 25% or has a sugar percentage of about 60 degrees for forming a paste; mixing the paste with a predetermined amount of malt; feeding the mixture into the closed space of very low humidity maintained at a temperature of about 18° C. to about 28° C. for drying until the mixture has a water percentage of about 12% to about 15%; lowering temperature of the closed space of very low humidity to about 4° C. to about 8° C. for hardening as blocks and grinding the blocks into coarse powder; further drying the coarse powder until the coarse powder has a water percentage less than about 9% and grinding same into fine powder; and packing the fine powder as bags or cans or forming same as capsules or small pieces.

Referring to FIG. 4, it is a flowchart depicting a process for processing vegetables or fruits of highly adhesive substance into very fine powder, capsules or small pieces according to a fourth preferred embodiment of the invention. The process comprises cutting vegetables or fruits of highly adhesive substance into small pieces; mixing the pieces with a predetermined amount of malt; feeding the mixture into the closed space of very low humidity maintained at a temperature of about 18° C. to about 28° C. for drying until the mixture has a water percentage of about 12% to about 15%; lowering temperature of the closed space of very low humidity to about 4° C. to about 8° C. for hardening as blocks and grinding the blocks into coarse powder; further drying the coarse powder until the coarse powder has a water percentage less than about 9% and grinding same into very fine powder; and packing the very fine powder as bags or cans or forming same as capsules or small pieces.

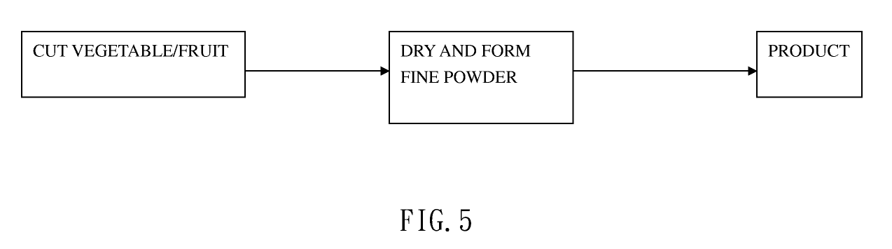

Referring to FIG. 5, it is a flowchart depicting a process for processing vegetables or fruits into very fine powder, capsules or small pieces according to a fifth preferred embodiment of the invention. The process comprises cutting vegetables or fruits of highly adhesive substance into small pieces; feeding the pieces into a closed space of very low humidity maintained at a temperature of about 18° C. to about 28° C. for drying until the pieces has a water percentage less than about 9% and grinding the pieces into very fine powder; and packing the very fine powder as bags or cans or forming same as capsules or small pieces.

It is contemplated by the invention that nutrients of the vegetables, fruits, fish, or meats are substantially preserved without significant loss.

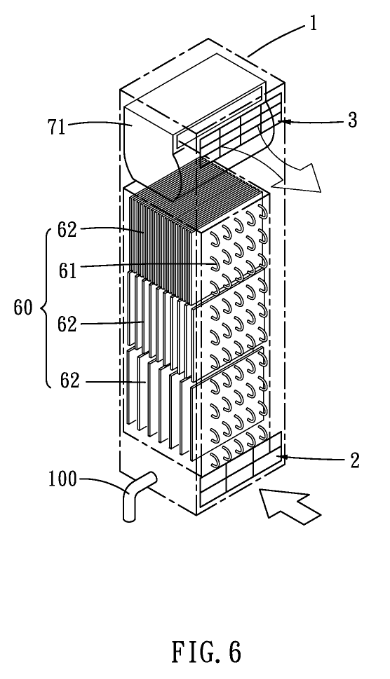

Referring to FIG. 6, a drying apparatus 1 mounted in the closed space according to the invention is shown. The apparatus 1 comprises a cold air inlet 2 in the bottom, a hot air outlet 3 proximate a top, an upright dehumidifier 60 including a condenser coil 61 and a plurality of fins 62 having a density increased gradually toward its top, a blower 71 for drawing cold air from the air inlet 2 into the dehumidifier 60 for dehumidification prior to discharging hot air through the air outlet 3, and a drain 100 for drawing condensed water from the dehumidifier 60.

Preferably, the dehumidifier 60 is capable of removing almost all moisture from air.

While the invention herein disclosed has been described by means of specific embodiments, numerous modifications and variations could be made thereto by those skilled in the art without departing from the scope and spirit of the invention set forth in the claims.

What is claimed is:

1. A method of processing foods comprising:
cutting vegetables, fruits, fish, or meats into pieces;
squeezing the pieces for juice;
drying the juice in a closed space having a humidity of about zero maintained at a temperature of about 18° C. to about 28° C. until the juice either has a water percentage of about 20% to about 25% or has a sugar percentage of about 60 degrees for forming a paste;
mixing the paste with a predetermined amount of malt to form a mixture;
feeding the mixture into the closed space for drying until the mixture has a water percentage of about 12% to about 15% and grinding same into coarse powder;
further drying the coarse powder until the coarse powder has a water percentage less than about 9% and grinding same into fine powder; and
packing the fine powder as products.

2. A method of processing foods comprising:
cutting vegetables of highly adhesive substance or fruits of highly adhesive substance into pieces;
squeezing the pieces for juice;
drying the juice in a closed space having a humidity of about zero maintained at a temperature of about 18° C. to about 28° C. until the juice either has a water percentage of about 20% to about 25% or has a sugar percentage of about 60 degrees for forming a paste;
mixing the paste with a predetermined amount of malt to form a mixture;
feeding the mixture into the closed space for further drying until the mixture has a water percentage of about 12% to about 15%;
lowering temperature of the closed space to about 4° C. to about 8° C. for hardening as blocks and grinding the blocks into coarse powder;
further drying the coarse powder until the coarse powder has a water percentage less than about 9% and grinding same into fine powder; and
packing the fine powder as products.

3. An apparatus for drying foods in a food processing, comprising:
an air inlet;
an air outlet;
a dehumidifier including a condenser coil and a plurality of fins having a density increased upward;
means for drawing air from the air inlet into the dehumidifier, and producing a current of air from the dehumidifier into the external through the air outlet; and
a drain for drawing condensed water from the dehumidifier.
